(19) United States
(12) Patent Application Publication
(10) Pub. No.: US 2014/0280297 A1
(43) Pub. Date: Sep. 18, 2014

(54) SEARCH ANNOTATION AND SUGGESTION

(71) Applicant: MICROSOFT CORPORATION, Redmond, WA (US)

(72) Inventors: Antonino Gulli, Pisa (IT); Arun K. Mehta, London (GB); Maria I. Carrelli, London (GB)

(73) Assignee: MICROSOFT CORPORATION, Redmond, WA (US)

(21) Appl. No.: 13/829,329

(22) Filed: Mar. 14, 2013

(51) Int. Cl. G06F 17/30

(52) U.S. Cl. CPC G06F 17/30389
USPC 707/769

(57) ABSTRACT

Digital content can be annotated with a search annotation. A user can specify or otherwise identify one or more terms, comprising a query, in conjunction with an annotation signal, for example. Suggestions can be provided automatically to aid a user in specifying the terms, among other things. Furthermore, a hyperlink can be generated that targets a search engine with the query or some other resource. Subsequently, the one or more terms are replaced with the hyperlink.

### BACKGROUND

Users of computing devices often toggle between two distinct environments, namely a primary environment and a search environment. In the primary environment, users may read or write social network posts, e-mails, or word processing documents, among other things. However, when a user would like to gather further information regarding something the user encountered in the primary environment, for example, the user transitions to the search environment. More specifically, a user opens a web browser, navigates to a search service webpage, formulates a query, and enters and submits the query. In response, the search service returns search results to the user on a search engine results page (SERP). If satisfactory results are not returned, the user can enter and submit a modified search to the search service, which returns new results to the user. Once desired information is located, the user shifts back to the primary environment until additional information is again desired and the process is repeated.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to search annotation and suggestion. A user can signal a desire to inject a search query, and more specifically a hyperlink, into digital content, for example utilizing one or more symbols and/or gestures. One or more terms, comprising a query for example, can be specified or otherwise identified in conjunction with a user's annotation signal. Subsequently, a hyperlink can be generated that targets a search engine with the query or some other resource (e.g., webpage), and the one or more terms and an associated annotation signal can be replaced with the hyperlink. Further, automatic suggestions can be supplied to aid a user in at least specifying a search query.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram a search annotation system.

FIGS. 2A-B illustrate exemplary screenshots of search annotation and suggestion in the context of a social network status update.

FIG. 3 is an exemplary screenshot depicting automatic query suggestion in the context of a word processing document.

FIG. 4 is an exemplary screenshot showing automatic query suggestion in the context of an e-mail.

FIG. 5 illustrates automatic query suggestion in connection with search annotation on a touch screen device.

FIG. 6 illustrates search annotation utilizing gesture on a touch screen device.

FIG. 7 is a flow chart diagram of a method of search annotation.

FIG. 8 is a flow chart diagram of a suggestion method.

FIG. 9 is a schematic block diagram illustrating a suitable operating environment for aspects of the subject disclosure.

### DETAILED DESCRIPTION

Details below generally concern search annotation and suggestion. In accordance with one embodiment, a user can signal a desire to embed a hyperlink within digital content. This annotation signal can be embodied as one or more symbols, gestures, or voice commands, among other things, which is followed by or otherwise associated with one or more terms, comprising a query, for example. Upon identification of a search annotation comprising a signal and a query, for instance, a hyperlink can be generated. The hyperlink can target a search engine with the query or some other resource (e.g., web page). Subsequently, the one or more terms, comprising the query, and associated annotation signal can be replaced with the hyperlink. As a result, others can easily acquire further information about a term or phrase, for example, by simply clicking on or otherwise following the link as opposed to opening a web browser, navigating to a search webpage, formulating a query, and entering and submitting the query. Further, automatic suggestion can be employed to aid user specification of a query in conjunction with search annotation, among other things. For example, one or more queries can be suggested as a function of a user entered search fragment or other information.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

Referring initially to FIG. 1, a search annotation system 100 is illustrated. The search annotation system 100 operates over content 110. More particularly, the search annotation system 100 enables content 110 or a portion thereof to be annotated with one or more search queries. Search terms comprising a query can be specified or otherwise identified in conjunction with a search annotation signal. A search hyperlink that targets a search engine with the query can then be generated, and the search query can be replaced with the search hyperlink. Subsequently, a user can easily initiate a targeted search, should more information be desired for instance, by selecting or otherwise following the link. In this case, a search engine results page (SERP) can be provided including results that are relevant to the query.

The content 110 is digital content. Herein, digital content, or simply content, includes anything that is published, distributed, or otherwise available in a digital form that supports inclusion of hyperlinks or the like This description focuses heavily on textual content associated with communications, such as instant messages, electronic mail, and social network posts, as well as written documents. However, content 110 is not limited to textual content or exemplary textual content described herein, but may also include images, diagrams, audio, video, or various combinations of different forms of digital content. Aspects of this disclosure can have broad applicability with respect to various types of content. Furthermore, content 110 can be accessed, read, or created within the context of various client services or applications. In accordance with one embodiment, the search annotation system 100 can operate separately from client services or applications, for example as a service itself. Alternatively, all or a portion of the search annotation system 100 can be integrated within client services or applications.

The search annotation system 100 includes a number of components that perform various functions related to annotating content with search queries and generation of hyperlinks. As shown, the search annotation system 100 includes content interface component 112, signal detection component 114, suggestion component 116, and hyperlink component 118. The content interface component 112 is configured to enable the search annotation system 100 to interact with the content 110. More specifically, content interface component 112 enables other components to at least acquire, alter, add, or remove content. The signal detection component 114 is configured to identify a signal that indicates a desire to inject a hyperlink within the content 110. The suggestion component 116 is configured to suggest one or more search terms comprising a query to aid search annotation, among other things. The hyperlink component 118 is configured to generate a hyperlink that in one embodiment targets a search engine with a query comprising one or more search terms and replace a query in the content with the hyperlink.

The signal detection component 114 is configured to detect an annotation signal, or more simply a signal, that indicates a desire to inject a search hyperlink or the like into the content 110. The functionality of the signal detection component 114 depends on the signal, which can take different forms. In accordance with one embodiment, the signal can correspond to one or more symbols or characters. According to another embodiment, the signal can correspond to a gesture. In the instance of symbols or characters, the signal in one instance can correspond to a question mark. In another instance, the signal can be “#b” followed by “/b.” A gesture can correspond to drawing one or more of the characters on a touch screen, touch pad or in the air in the direction of a motion camera, among other things. However, the gesture need not be limited thereto. By way of example, and not limitation, the gesture can be any action captured by one or more input devices such as, but not limited to, a touch screen, touchpad, mouse, stylus, keyboard, camera, microphone, or natural user interface (NUI) that enable all or portions of content to be selected. The signal detection component 114 can be configured to detect one or all manners in which a signal is embodied.

The suggestion component 116 is configured to automatically suggest or recommend queries comprising one or more search terms to aid search annotation. In one embodiment, suggestions can be supplied automatically as a function of text input entered after a search annotation signal, for instance as text is input character by character. For example, a suggestion can be made that completes or adds one or more search terms (e.g. prefix and/or suffix terms) to a query fragment comprising one or more search terms or a portion thereof (e.g., one or more character). More specifically, from the query fragment “Ha,” suggestions can include “Black Hat” as well as “Red Hat.” Furthermore, content prior to the signal or other context information can be employed in automatic suggestion alone or in combination with input received after the signal. Utilizing content prior to the signal or other context information can increase the relevancy of suggested queries. Additionally, since suggestions can be provided prior to any input from a user, the queries can provide a starting point for user query specification.

The hyperlink component 118 is configured to inject hyperlinks into the content 110. Given a query comprising one or more search terms, the hyperlink component 118 can generate or otherwise obtain a hyperlink that targets a search engine with the query. A hyperlink provides a link from a source to a target. Further, a hyperlink includes display text that is clickable, or, in other words, is able to be activated or followed. As used herein, a search hyperlink is a type of hyperlink that targets a search engine and passes a query to the search engine. The display text of a search hyperlink can be search terms that comprise the query although that need not be the case. Upon following the search hyperlink, results of the search can be provided, for example on a search engine results page (SERP). The hyperlink component 118 is also configured to replace a search annotation comprising a signal and query, for example with a hyperlink including the query. By way of example, consider a query comprising a single search term “cuneiform.” In this case, the query is replaced with a search hyperlink with display text “cuneiform” that targets a search engine with the query as follows: “http://www.bing.com/search?q=cuneiform.”

In accordance with one embodiment, the hyperlink component 118 can generate the hyperlink. However, hyperlink server 130 can store a number of popular hyperlinks including potentially hyperlinks generated by the hyperlink component 118. If available, the hyperlink component 118 can acquire one or more hyperlinks from the hyperlink server 130.

Although not limited thereto, suggestions can be acquired from suggestion server 120 of a search engine. The suggestion server 120 can be the same server the search engine employs to suggest search queries. Accordingly, the vast and up-to-date suggestions employed by the search engine can be exploited for annotation. In this scenario, the suggestion component 116 can acquire pertinent data, pass the data to the suggestion server 120, and present the resulting suggestions, or a subset thereof, to a user in a drop down list or separate window panel, for example. The particular search engine utilized can be configurable. Moreover, various features of the suggestion server 120 can be exploited to aid a user in annotating content.

By way of example, in addition to providing query suggestions, the suggestion server 120 can provide addresses to specific resources (e.g., uniform resource identifiers (URI), uniform resource locators (URL) . . . ) and optionally show previews (e.g. thumbnails) of content prior to formally submitting a request. The suggestion server 120 can draw on a user's search history, search history of other users, and/or popular content to suggest particular resources such as webpages and optionally provide a preview. In other words, suggestion need not be limited to query suggestion. In this case, a user annotating content may select specific resources to associate with a query. As a result, rather than a hyperlink targeting a search engine with a query, the hyperlink can target specific content such as a specific webpage.

Further, suggestion component 116, or a subcomponent thereof, can be configured to provide suggestions with respect to when content should potentially be annotated with a hyperlink. For instance, as a user is specifying or otherwise building content, the content can be analyzed. If a word, for example, is not common or well understood, or has the potential to be ambiguous, the suggestion component 116 can automatically suggest, or recommend, that a hyperlink to more information be inserted. In one embodiment, a user can be signaled in some way that a hyperlink is suggested, for example by altering a font style (e.g., bold, italicize, underline . . . ), changing color, and/or applying some effect (e.g., highlight). In another embodiment, query suggestion can be initiated. For instance, as a user is typing if it can be determined or inferred that the word or phrase being input is not common or well understood query suggestion can be initiated. In other words, a user need not explicitly initiate suggestion.

The functionality of suggestion component 116 need not be limited to aiding initial specification of a search query. In accordance with another embodiment, if the original query annotating content provides search results that a user, who is consuming content and has followed a hyperlink, is not satisfied with then the suggestion component 116 can assist in providing additional suggestions. A user could signal dissatisfaction with search results differently than annotation. Upon receipt of this signal, alternative query suggestions could be presented related to the original query suggestion. For example, the user could cause a cursor to hover over a search hyperlink and a number of related queries can then be returned as suggestions. In one embodiment, the search hyperlink could be reformulated to include a selected query and allow a user to initiate a search and receive results. Alternatively, the returned search suggestions could be embodied as hyperlinks to enable the search to be initiated simply by selecting a suggested query.

What follows is a discussion of a few exemplary scenarios to aid clarity and understanding with respect various aspects of the subject disclosure. These examples are not the only scenarios in which aspects of the disclosure are applicable, and the appended claims are not intended to be limited to these exemplary scenarios or particulars of an exemplary scenario unless explicitly stated.

Search annotation is applicable in a social network service environment. FIGS. 2A-B illustrate exemplary screenshots of search annotation in the context of a status update or post. FIG. 2A depicts text input box 200 for users to input a status or comment. The user first typed, “I wanted to highlight.” Next, the user input a question mark character 220, which, in this is example, is the signal that the user desires to inject a search hyperlink. Following the question mark character 220, the user inputs a query fragment “Quantum th” 230. In response, query suggestions 240 are provided in a drop down list. Assuming the user selected the first query suggestion “quantum theory,” or continued to type the same in the text box, as well as additional text “If you are interested in knowing more, click on the link,” the result, posted in a news feed for example, is shown in FIG. 2B. Here, the text content 250 includes a search hyperlink for “Quantum Theory” that replaces the search annotation comprising a signal and query, namely “?Quantum Theory.” Subsequently, if a social network service connection sought to obtain more information about quantum theory, the connection could click on the link and be transported to a search-engine result page including results for the query “Quantum Theory.”

FIG. 3 is an exemplary screenshot illustrating search suggestion in the context of a word processing document. Here, a sentence 310 is input in a word processing document. The author would like to insert a search query at the end of the sentence. In particular, a query fragment 312 is input following the question mark signal, “?Sharep.” In response, search suggestions are provided in a distinct window panel 320 labeled “Search Suggestions,” rather than a drop down list. Suggested search queries 322 are presented that complete the query fragment 312. The query suggestions 322 can also be provided as a function of other content up to the signal. For example, “SkyDrive Pro was previewed at the recent” as well as any other information, such as the title of the document, can be utilized as context to influence suggestions in way that makes the suggestions more effective. Further, the differences between the query suggestions and the text input can be emphasized in an example embodiment to aid selection. Here, for instance, the differences are shown in bold, but other forms of emphasis could be employed (e.g., different color, italicized, underlined . . . ). Still further, control can be transferred temporarily to the search-suggestion window panel 320 to enable further query specification or selection of a suggestion.

Assume a user selects (by way of a selection signal (e.g., gesture, voice command . . . ) the first suggestion “sharepoint” and ends the sentence with a period. The result would read, “SkyDrive Pro was previewed at the recent sharepoint.” The underline of “sharepoint” indicates that the single search term query was converted into a search hyperlink and injected in-line (e.g., on the same line) with the text replacing the signal and query fragment “?Sharep.” Subsequently, anyone that clicked on the hyperlink would receive search results produced by a search engine in response to the query.

FIG. 4 is an exemplary screenshot depicting search suggestion in connection with search annotation in an e-mail. Upon quick glance, it is clear that search suggestion in connection with annotation operates substantially the same in an e-mail context as it does in the word processing document context. In this situation, a sentence 410 is entered into an e-mail message that includes a signal indicative of a desire to insert a search hyperlink, namely the question mark, and query fragment “Bara” 412. In response, suggestions are provided in a window panel 420 separate from the e-mail. Query suggestions 422 are presented in response to at least the query fragment “Bara” 412. It might also be the case that text preceding the signal as well as other information in the such as the subject of the e-mail is considered in connection with determining which suggestions to provide and/or which order to present the suggestions. In other words, the entire e-mail can become context for influencing the suggestions. For example, “Baraboo School District” might be the first suggestion because there was an announcement by the school. Assuming a user selects the first suggestion in the query suggestions 422 and ends the sentence with a question mark, the result is, “Did you see the announcement by Baraboo School District?” Here, the underline indicates the presence of a search hyperlink. The hyperlink target can be specified to include the query “Baraboo School District” as follows: “http://www.bing.com/search?q=baraboo+school+district.” Selection of the link by way of a selection signal (e.g., gesture, voice command . . . ) would cause navigation to a search-engine result page including information about the school district.

FIG. 5 illustrates search suggestion in connection with search annotation on a touch screen device 500. Here, a user indicates a desire to insert a search hyperlink with a gesture drawing a question mark 510 on the touch screen. Consequently, a search suggestion box 520 is provided to enable a user to specify a search query. Moreover, search suggestions 530 are provided in a dropdown list. If a user selects the last suggestion, the result would be “That guy looks like Brad Paisley,” where “Brad Paisley” is display text of a search hyperlink including the query comprising search terms “Brad Paisley.”

Although not illustrated, it is also to be appreciated that content can be annotated with a search annotation and search suggestion initiated in connection with a myriad of other input devices. By way of example, interaction can occur utilizing a motion camera. In this case, a search query can be signaled with a question mark gesture drawn in the air and captured by the motion camera. Subsequently, a query can be entered or selected from a list of suggestions. The result would again be a search hyperlink targeting a search engine and passing the query.

Further, search annotation can be performed after content is specified. For example, a signal can be employed to indicate that a particular word or words should be interpreted as one or more search terms of a query and replaced with a search hyperlink. Again, the signal can be substantially any symbol, combination of one or more symbols, gestures, or voice commands. For example, consider the text content sentence “That guy looks like Brad Paisley.” After the sentence was written, the author might have realized that not everyone knows of Brad Paisley. To initiate transformation “Brad Paisley” into a search hyperlink utilizing the search annotation system 100, the author could use symbols. For example, “?Brad Paisley?” or “#bBrad Paisley/b.” Additionally or alternatively, a gesture could be utilized to identify a search terms of a query. Turning briefly to FIG. 6, a touch screen device 500 is illustrated that is displaying the sentence “That guy looks like Brad Paisley.” Here, a circular gesture 610 is employed to identify “Brad Paisley” as the query. Regardless of the signal, the result can be the same. That is, “Brad Paisley” will be replaced with a search hyperlink that targets a search engine with the query “Brad Paisley.” Subsequently, if the search hyperlink is selected, a search engine result page (SERP) can be displayed that includes results of a search for “Brad Paisley.”

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the suggestion component 116 can employ such mechanism to identify and order query suggestions for example as a function of historical information.

In view of the exemplary systems described above, methodologies that may be implemented in accordance with the disclosed subject matter will be better appreciated with reference to the flow charts of FIGS. 7 and 8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, a method of search annotation 700 is illustrated. At reference numeral 710, annotation of content initiated. In accordance with one embodiment, annotation can be initiated upon receipt retrieval, detection, or identification of a signal. The signal can express a desire to inject or embed a hyperlink in content. The signal can correspond to one or more symbols and/or gestures such as, but not limited to, a question mark, a combination of “#b” and “/b,” a single- or multi-touch gesture on a touch screen, face/hand/body motion detected by an image capture device, and motion of a cursor detected by a mouse or other input device. Still further yet, a signal can be embodied as one or more voice commands. In another embodiment, annotation can be initiated automatically for example in a particular context or upon a determination that it would be beneficial to consumers of the content to annotate all or a portion of content.

At numeral 720, a query comprising one or more search terms is received, retrieved, or otherwise obtained or acquired. Search terms can be by specified by a user in combination with a search annotation signal, for instance “?tropical fish diseases” or “#btropical fish diseases/b.” Alternatively, one or more search terms comprising a query can be identified by selecting previously specified content by the user or someone else, for example by inserting symbols surrounding terms or with a gesture that selects the terms.

At reference 730, a hyperlink is generated. The hyperlink can include display text and a target link. In one embodiment, display text can include the query search terms and the target or destination link can be a search engine address together with the query. For example, for the query “tropical fish diseases,” the display text is the query “tropical fish diseases” and the target link address can be “www.bing.com/search?q=tropical+fish+diseases.” In another embodiment, the display text can be a query, or selected content words or phrases, and the target link can be a uniform resource identifier (URI) that identifies a web resource such as a specific webpage.

At reference numeral 740, the hyperlink is injected in content. More particularly, a search annotation comprising any visible signal and a query can be replaced with the hyperlink.

FIG. 8 is a flow chart diagram of a method of suggestion 800. At reference numeral 810, suggestion is initiated. In one embodiment, suggestion can be initiated in response to a signal that is received, retrieved, detected, or otherwise identified. The signal, which can be embodied as one or more symbols and/or gestures, among other things, can trigger automatic suggestion with respect to search annotation. In another embodiment, suggestion can be triggered automatically without an explicit user signal, for example in a particular context or upon a determination that it would be beneficial to consumers of the content to annotate all or a portion of content. At numeral 820, text input corresponding to a query or query fragment, for example, is received, retrieved, or otherwise obtained or acquired. In one instance, during query specification text following the annotation signal can be acquired, for example as one or more search terms are specified (e.g., character by character). In another instance, however, previously specified or preexisting text can be received, retrieved, or otherwise obtained or acquired. At reference numeral 830, context can be received, retrieved, or otherwise obtained or acquired. Context can correspond to other text surrounding the text input. For example, context can refer to the text specified prior to the input text or the title of a corresponding document for example, among other things. At numeral 840, one or more search terms comprising a query and/or uniform resource identifiers (URIs) identifying web resources can be suggested based on acquired input. By way of example, one or more search terms and/or one or more (URIs) can be suggested based on text input in a drop down list or separate window panel. Subsequently, specified portions of one or more query terms can then be utilized to suggest search term completions and optionally additional search terms (e.g., suffix and/or prefix terms).

Suggestion is not limited to specification. In accordance with another embodiment search if the original query does not provide results that a user is looking for, additional suggestions can be provided. In this instance, the search signal can be different. For example, the user could cause a cursor to hover over the query. The text input can correspond to the displayed query search terms, and a number of related queries can then be returned as suggestions. A search hyperlink could be reformulated to include a selected query to allow a user to initiate a search and receive results. Alternatively, the returned search suggestions could be hyperlinks to enable the search to be initiated simply by selecting a suggestion.

Other technologies can exploit annotating content with queries or more particularly search hyperlinks. By way of example, and not limitation, electronic advertisement systems could utilize the queries as a basis for identifying and presenting relevant advertisements.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component,” “system,” and “engine” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 9, illustrated is an example general-purpose computer 910 or computing device (e.g., desktop, laptop, tablet, server, hand-held, programmable consumer or industrial electronics, set-top box, game system, compute node . . . ). The computer 910 includes one or more processor(s) 920, memory 930, system bus 940, mass storage 950, and one or more interface components 970. The system bus 940 communicatively couples at least the above system components. However, it is to be appreciated that in its simplest form the computer 910 can include one or more processors 920 coupled to memory 930 that execute various computer executable actions, instructions, and or components stored in memory 930.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration.

The computer 910 can include or otherwise interact with a variety of computer-readable media to facilitate control of the computer 910 to implement one or more aspects of the claimed subject matter. The computer-readable media can be any available media that can be accessed by the computer 910 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store the desired information and accessed by the computer 910. Furthermore, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 930 and mass storage 950 are examples of computer-readable storage media. Depending on the exact configuration and type of computing device, memory 930 may be volatile (e.g., RAM), non-volatile (e.g., ROM, flash memory . . . ) or some combination of the two. By way of example, the basic input/output system (BIOS), including basic routines to transfer information between elements within the computer 910, such as during start-up, can be stored in nonvolatile memory, while volatile memory can act as external cache memory to facilitate processing by the processor(s) 920, among other things.

Mass storage 950 includes removable/non-removable, volatile/non-volatile computer storage media for storage of large amounts of data relative to the memory 930. For example, mass storage 950 includes, but is not limited to, one or more devices such as a magnetic or optical disk drive, floppy disk drive, flash memory, solid-state drive, or memory stick.

Memory 930 and mass storage 950 can include, or have stored therein, operating system 960, one or more applications 962, one or more program modules 964, and data 966. The operating system 960 acts to control and allocate resources of the computer 910. Applications 962 include one or both of system and application software and can exploit management of resources by the operating system 960 through program modules 964 and data 966 stored in memory 930 and/or mass storage 950 to perform one or more actions. Accordingly, applications 962 can turn a general-purpose computer 910 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the search annotation system 100, or portions thereof, can be, or form part, of an application 962, and include one or more modules 964 and data 966 stored in memory and/or mass storage 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the search annotation system 100 and/or associated functionality can be embedded within hardware in a SOC architecture.

The computer 910 also includes one or more interface components 970 that are communicatively coupled to the system bus 940 and facilitate interaction with the computer 910. By way of example, the interface component 970 can be a port (e.g., serial, parallel, PCMCIA, USB, FireWire . . . ) or an interface card (e.g., sound, video . . . ) or the like. In one example implementation, the interface component 970 can be embodied as a user input/output interface to enable a user to enter commands and information into the computer 910, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 970 can be embodied as an output peripheral interface to supply output to displays (e.g., CRT, LCD, LED, plasma . . . ), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A computer-implemented method, comprising:
identifying a signal indicative of a desire to inject a hyperlink; and
suggesting one or more queries as a function of textual input following the signal.

2. The method of claim 1 further comprises suggesting the one or more queries as a function of one or more words that precede the signal.

3. The method of claim 1 further comprises receiving a selection of one of the one or more queries.

4. The method of claim 3 further comprises generating a hyperlink targeting a search engine with the one of the one or more queries.

5. The method of claim 4 further comprises replacing the one of the one or more queries with the hyperlink.

6. The method of claim 1 comprises identifying a question mark as the signal.

7. The method of claim 6 comprises identifying a question mark gesture as the signal.

8. The method of claim 1 further comprises presenting the one or more queries in a drop down list.

9. The method of claim 1 further comprises presenting the one or more queries in a distinct window panel.

10. The method of claim 1 further comprises suggesting one or more uniform resource identifiers identifying a web resource as a function of the textual input.

11. A system, comprising:
a processor coupled to a memory, the processor configured to execute the following computer-executable components stored in the memory:
a first component configured to identify an annotation signal in-line with text; and
a second component configured to automatically suggest one or more queries comprising one or more search terms based on a query fragment following the signal.

12. The system of claim 11, the second component is further configured to suggest the one or more queries as a function of text input prior to the signal.

13. The system of claim 11 further comprises a third component configured to generate a search hyperlink that targets a search engine one of the one or more queries.

14. The system of claim 11, the annotation signal is a question mark.

15. The system of claim 11, the annotation signal is a gesture.

16. The system of claim 11, the second component is configured to present the one or more queries in a distinct window panel.

17. A computer-readable storage medium having instructions stored thereon that enable at least one processor to perform a method upon execution of the instructions, the method comprising:
identifying a signal indicative of a desire to inject a hyperlink;
acquiring a query comprising one or more search terms following the signal;
generating a hyperlink that targets a search engine with the query; and
replacing the query with the hyperlink.

18. The method of claim 17 further comprises suggesting the query automatically as a function of a query fragment.

19. The method of claim 18 further comprises suggesting the query automatically as a function of one or more words that precede the signal.

20. The method of claim 17 comprises identifying a question mark as the signal.
